(19) United States
(12) Patent Application Publication
(10) Pub. No.: US 2007/0170124 A1
(43) Pub. Date: Jul. 26, 2007

(54) Ozone supply system

(76) Inventor: Samir Said, Los Angeles, CA (US)

Correspondence Address: KEVIN J. MCNEELY, ESQ., 5335 WISCONSON AVENUE, NW, SUITE 440, WASHINGTON, DC, 20015, US

(21) Appl. No.: 11/339,675

(22) Filed: Jan. 26, 2006

(51) Int. Cl. C02F 1/78

(52) U.S. Cl. 210/760; 210/192

(57) ABSTRACT

An ozone supply system includes an ozone generator, an ozone supply hose, and a supply wand with a handle having an activation switch to operate the ozone generator. An ozone supply system mounted in a sink cabinet includes an ozone generator, a wand, an ozone supply hose connecting the ozone generator to the wand and a wand holder attached to a surface of the sink cabinet.

### BACKGROUND

Ozone (O3) is found commonly in nature. Ozone is formed whenever lightning occurs, or when an electrical discharge creates a spark. The ozone layer in the upper atmosphere provides a protective screen against dangerous solar radiation. The generation of ozone is a relatively simple process. Air or oxygen is drawn into the ozone generator, at which point the air is charged with high voltage. The air is made up of diatomic oxygen (O2) and nitrogen (N2). Diatomic oxygen is a molecule composed of two oxygen atoms (O) held together by four equally shared electrons. As the air is drawn through the ozone generator, the high voltage splits some oxygen molecules into oxygen atoms. Some of these atoms then quickly react with oxygen molecules to form ozone: (O1)+(O2)=(O3).

Ozone is a powerful oxidizer and has the ability to neutralize many organic and inorganic compounds. While oxygen has a stable electrical bond, ozone is very reactive which allows it to be able to combine with and neutralize chemicals, free radicals and pathogens, and to oxygenate the bloodstream. Thus, ozone is thought to improve the health of the body and various types of ozone generators are available to “ozonate” drinking water.

Various types of commercially available ozone generators for water treatment use plasma, corona discharge, or ultraviolet light to produce ozone. Some of these ozone generators are designed specifically to ozonate drinking water, however, they are not always readily accessible and typically require some set-up time. Thus, a need exists for an ozone supply system that is easy to use to ozonate drinking water.

### SUMMARY

An ozone supply system includes an ozone generator, an ozone supply hose, and a supply wand with a handle having an activation switch to operate the ozone generator. Embodiments may include one or more of the following features.

For example, the ozone generator may have an ozone chamber, an air compressor and a power supply. The power supply may provide power to the ozone chamber and the air compressor when the activation switch is activated.

As another example, a set of conductors may connect the power supply to the activation switch. A first conductor may be connected to a first contact of the activation switch and a second conductor may be connected to a second contact of the activation switch. A push button may be used to make an electrical connection between the first contact and the second contact.

In another general aspect, an ozone supply system mounted in a sink cabinet includes an ozone generator, a wand, an ozone supply hose connecting the ozone generator to the wand and a wand holder attached to a surface of the sink cabinet. Embodiments may include one or more of the above or following features.

For example, the wand holder may have a channel that accommodates the ozone supply hose. The wand holder may also have a threaded portion with a nut threaded onto the threaded portion.

In a further general aspect, a method of ozonating drinking water with an ozone generator that includes a supply wand with handle having an activation switch includes positioning the supply wand in a glass of drinking water and pressing the activation switch on the handle of the supply wand.

### DESCRIPTION OF THE FIGURES

FIG. 1 shows a sink-mounted ozone supply system.

FIG. 2 shows an ozone generator.

FIG. 3 shows an ozone supply wand.

### DETAILED DESCRIPTION

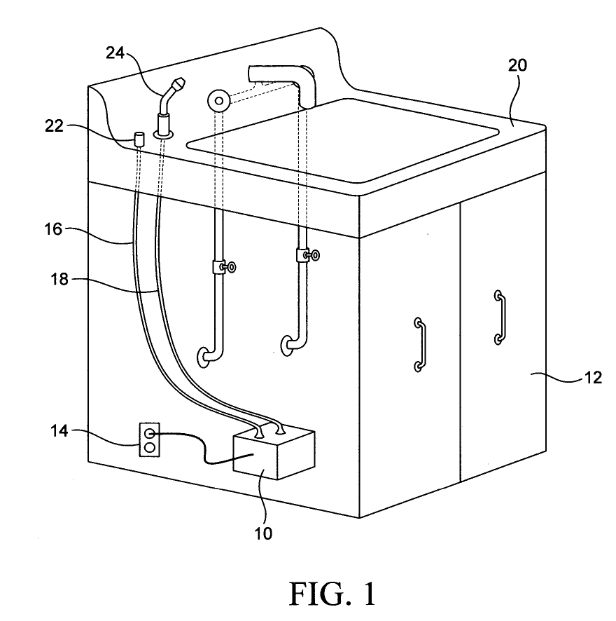

Referring to FIG. 1, a sink-mounted ozone supply system includes include an ozone generator mounted in a wash cabinet 12. The ozone generator is connected to a power source 14 and has an air intake hose 16 and an ozone supply hose 18. The air intake hose 16 is fed through an opening in the sink top and attaches to an air intake port 22 mounted to the sink top 20. The ozone supply hose 18 is also fed through an opening in the sink top 20 and is attached to an ozone supply wand 24.

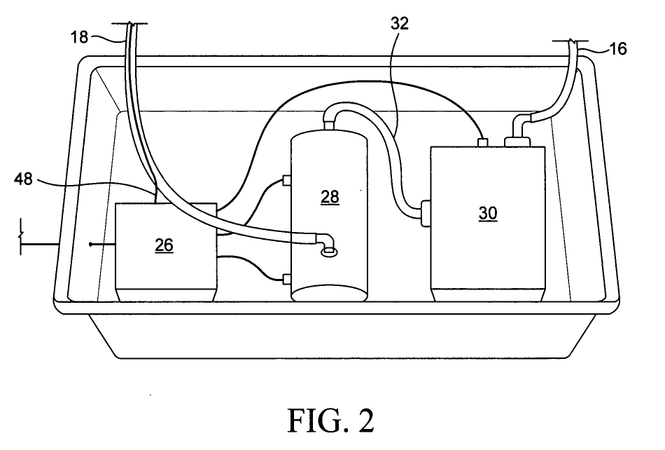

Referring to FIG. 2, the ozone generator 10 includes a power supply 26, an ozone chamber 28, and an air compressor 30. The power supply 26 provides power to the ozone chamber 28 and the air compressor 30. Fresh air is provided to the air compressor 30 through the air intake hose 16. Pressurized air is then fed through an air hose 32 between the air compressor 30 and the ozone chamber 28. Ozone exits the ozone chamber 28 through the ozone supply hose 18.

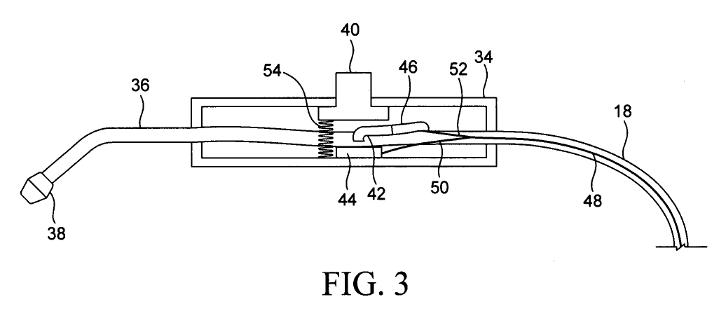

Referring to FIG. 3, the wand includes a handle 34 and a rigid supply tube 36 with a nozzle 38. A push button 40 for an activation switch 42 protrudes from the handle 34. The activation switch 42 has contacts 44, 46 that are connected together when the push button 40 is depressed.

A two conductor power cord 48 is embedded in the supply hose 18 with the first conductor 50 attached to the first contact 44 and the second conductor 52 attached to the second contact 46. When the push button 40 is released, a spring causes the push button 40 to extend further from the 34 handle thereby switching the contacts 44, 46 back to the open position. Thus, the activation switch 42 acts as an on/off switch for the power supply 28 to provide power to the ozone chamber 28 and the air compressor 30.

Use of the ozone generator is convenient. The user fills a glass with drinking water and positions the wand in the glass of water. The user then presses the activation button thereby switching on the ozone generator. Ozone is pumped out of the nozzle and into the drinking water. After ozonating the drinking water for a period of time, the user releases the activation button which shuts off the ozone generator. The user then repositions the wand on the sink top.

1. An ozone supply system, comprising:
an ozone generator;
an ozone supply hose; and
a supply wand with a handle having an activation switch to operate the ozone generator.

2. The ozone supply system of claim 1, wherein the ozone generator comprises:
an ozone chamber;
an air compressor; and
a power supply supplying power to the ozone chamber and the air compressor when the activation switch is activated.

3. The ozone supply system of claim 2, further comprising:
a first conductor and a second conductor being connected between the activation switch and the power supply.

4. The ozone generator of claim 3, wherein the activation switch further comprises:
a first contact, a second contact, and a push button;
wherein
the first conductor connects to the first contact;
the second conductor connects to the second contact; and
the push button is configured to make an electrical connection between the first contact and the second contact by pressing the push button.

5. An ozone supply system mounted in a sink cabinet, comprising:
an ozone generator;
a wand;
an ozone supply hose connecting the ozone generator to the wand; and
a wand holder attached to a surface of the sink cabinet.

6. The ozone supply system of claim 5, wherein the wand holder includes a channel having a width sufficient to accommodate the ozone supply hose.

7. The ozone generator of claim 5, wherein the wand holder includes a threaded portion and a nut being threadable onto the threaded portion.

8. A method of ozonating drinking water with an ozone generator that includes a supply wand with handle having an activation switch, comprising:
positioning the supply wand in a glass of drinking water; and
pressing the activation switch on the handle of the supply wand.
